(19) United States
(12) Patent Application Publication
(10) Pub. No.: US 2025/0347334 A1
(43) Pub. Date: Nov. 13, 2025

(54) AIR DAMPER

(71) Applicant: HYUNDAI MOBIS CO., LTD., Seoul (KR)

(72) Inventor: Yong Gon MOON, Yongin-si (KR)

(73) Assignee: HYUNDAI MOBIS CO., LTD., Seoul (KR)

(21) Appl. No.: 18/829,709

(22) Filed: Sep. 10, 2024

(30) Foreign Application Priority Data
May 8, 2024 (KR) 10-2024-0060573

(51) Int. Cl. F16F 9/512; F16F 9/02; F16F 9/342

(52) U.S. Cl. CPC F16F 9/512; F16F 9/0218; F16F 9/0281; F16F 9/342; F16F 2222/126; F16F 2228/066; F16F 2230/0052; F16F 2230/36

(57) ABSTRACT

An air damper includes: a cylinder; a partition wall dividing an internal space of the cylinder into a first chamber and a second chamber; a piston movably installed in the first chamber; a guide rod extending from the partition wall toward the second chamber and including a transfer hole connected to the first chamber and the second chamber; a valve movably installed in the second chamber and configured to move in conjunction with a pressure difference between the first chamber and the second chamber; an orifice positioned between the guide rod and the valve and connected to the second chamber and the transfer hole; and a slit provided on the guide rod or the valve and connected to the orifice.

### CROSS-REFERENCE TO RELATED APPLICATION

This application claims priority from and the benefit of Korean Patent Application No. 10-2024-0060573, filed on May 8, 2024, which is hereby incorporated by reference for all purposes as if set forth herein.

### BACKGROUND

### Field

Exemplary embodiments of the present disclosure relate to an air damper, and more particularly, to an air damper, which may control the opening and closing speed of a glove box.

### Discussion of the Background

In general, a glove box for storing simple items is placed on a dashboard or instrument panel of a vehicle. Here, the glove box is typically placed in front of the passenger seat.

The glove box uses a cover to open or close an interior space thereof for storing items. A damper is installed to prevent sudden movement of the cover when the interior space is opened or closed.

The damper includes a cylinder and a piston, and if necessary, a valve may be installed on one side of the cylinder to control the speed of the piston.

### SUMMARY

Various embodiments are directed to an air damper, which may compensate for a change in an area of an orifice caused by thermal expansion of a component.

In an embodiment, an air damper may include: a cylinder; a partition wall dividing an internal space of the cylinder into a first chamber and a second chamber; a piston movably installed in the first chamber; a guide rod extending from the partition wall toward the second chamber and including a transfer hole connected to the first chamber and the second chamber; a valve movably installed in the second chamber and configured to move in conjunction with a pressure difference between the first chamber and the second chamber; an orifice positioned between the guide rod and the valve and connected to the second chamber and the transfer hole; and a slit provided on the guide rod or the valve and connected to the orifice.

The valve may include: a valve body; a valve rod extending from the valve body and surrounding the guide rod; and an elastic member positioned between the partition wall and the valve body. The slit may be positioned on the guide rod and recessed in a first direction from an outer peripheral surface of the guide rod.

A cross-sectional area of the guide rod may increase toward the partition wall.

The guide rod may be arranged relative to the valve such that the outer peripheral surface thereof is arranged to be inclined with respect to a moving direction of the valve.

A width of the slit may increase toward an outer peripheral surface of the valve.

The slit may include a first end and a second end spaced apart from the first end along a second direction perpendicular to the first direction. A distance between the first end and the second end may be greater than the width of the slit.

The guide rod may include a guide end surface perpendicular to the moving direction of the valve. The first end of the slit may penetrate the guide end surface of the guide rod.

The air damper may further include an inclined surface facing the second end of the slit and extending obliquely from the outer peripheral surface of the guide rod toward a bottom surface of the slit.

The valve may include: a valve body; a valve rod extending from the valve body and inserted into the transfer hole; and an elastic member positioned between the partition wall and the valve body. The slit may be provided on the valve rod and recessed in the first direction from an outer peripheral surface of the valve rod.

A cross-sectional area of the valve rod may decrease toward the partition wall.

The guide rod is arranged relative to the guide rod such that the outer peripheral surface thereof may be arranged to be inclined with respect to the moving direction of the valve.

The width of the slit may increase toward the outer peripheral surface of the valve rod.

The slit may include a first end and a second end spaced apart from the first end along a second direction perpendicular to the first direction. The distance between the first end and the second end may be greater than the width of the slit.

The valve rod may include a valve end surface perpendicular to a moving direction of the valve body. The first end of the slit may penetrate the valve end surface of the guide rod.

The air damper may further include an inclined surface facing the second end of the slit and extending obliquely from the outer peripheral surface of the valve rod toward the bottom surface of the slit.

According to the present disclosure, the air damper may keep the opening speed of the glove box constant, regardless of the load applied to the glove box, by using the valve which adjusts a cross-sectional area of the orifice based on the pressure difference between the first and second chambers.

According to the present disclosure, the air damper may prevent an excessive increase in the opening time of the glove box under a high-temperature condition by preventing a decrease in the cross-sectional area of the orifice, or partially offsetting (the amount of) the decrease in the cross-sectional area of the orifice, through volume expansion of the slit upon thermal expansion of the guide rod or the valve rod.

According to the present disclosure, the air damper may prevent a non-linear change in a damping force by using the inclined surface to linearly change the cross-sectional area of the orifice at an end of the slit.

### BRIEF DESCRIPTION OF THE DRAWINGS

FIG. 1 is a view schematically illustrating the installation state of an air damper according to an embodiment of the present disclosure.

FIG. 2 is a perspective view schematically illustrating the configuration of the air damper panel according to an embodiment of the present disclosure.

FIG. 3 is a cross-sectional perspective view schematically illustrating the configuration of the air damper according to an embodiment of the present disclosure.

FIG. 4 is an enlarged view schematically illustrating the configuration of the air damper according to an embodiment of the present disclosure.

FIG. 5 is a cross-sectional view taken along line 5-5′ in FIG. 4.

FIG. 6 is a view schematically illustrating the installation state of a slit according to an embodiment of the present disclosure.

FIG. 7 is a perspective view schematically illustrating the configuration of the slit according to an embodiment of the present disclosure.

FIGS. 8 and 9 are cross-sectional views schematically illustrating the configuration of the slit according to an embodiment of the present disclosure.

FIGS. 10 and 11 are views illustrating modifications of the cross-sectional shape of the slit according to an embodiment of the present disclosure.

FIG. 12, FIG. 13, FIG. 14, FIG. 15, FIG. 16, FIG. 17, FIG. 18, and FIG. 19 are views schematically illustrating an operation process of the air damper according to an embodiment of the present disclosure.

FIG. 20 is a cross-sectional view schematically illustrating the configuration of the air damper according to another embodiment of the present disclosure.

FIGS. 21 and 22 are cross-sectional views schematically illustrating the configuration of the slit according to another embodiment of the present disclosure.

### DETAILED DESCRIPTION OF THE ILLUSTRATED EMBODIMENTS

Hereinafter, an air damper will be described below with reference to the accompanying drawings through various exemplary embodiments.

It should be considered that the thickness of each line or the size of each component in the drawings may be exaggeratedly illustrated for clarity and convenience of description. In addition, the terms as used herein are defined in consideration of functions of the present disclosure, and these terms may change depending on an occupant or operator's intention or practice. Therefore, definitions of these terms will have to be made based on the content herein.

In addition, in the present specification, when one element is described as being “connected (or coupled)” to another element, it may be “directly connected (or coupled)” to another element, or may be “indirectly connected (or coupled)” to another element with other elements interposed therebetween. In some embodiments, when one element is described as being “connected” or “coupled” to another element it may include that the elements are fluidly connected to one another such that both are in fluid communication with each other. In the present specification, when one element is described to “comprise (or include)” one element, this is not intended to preclude any other elements, but rather may further “comprise (or include)” other elements, unless specifically stated otherwise.

In addition, the same reference numerals may refer to the same elements herein. Even if the same or similar reference numerals are not mentioned or described in a particular drawing, such reference numerals may be described on the basis of other drawings. Similarly, even if one element is not identified by a reference numeral in a particular drawing, the element may be described on the basis of other drawings. In addition, the number, shape, size, and relative differences in size of constituent elements, and the like illustrated in the drawings of the present disclosure are set for ease of understanding. Embodiments are not limited thereto, and may be implemented in various forms.

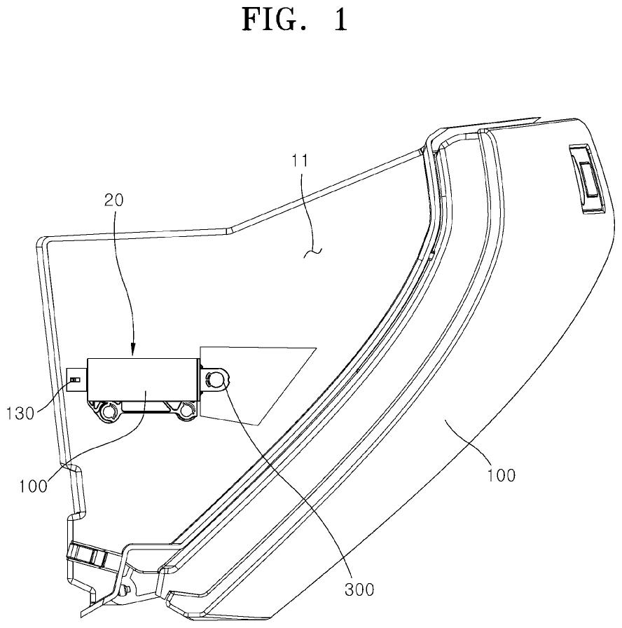

FIG. 1 is a view schematically illustrating the installation state of an air damper according to an embodiment of the present disclosure.

Referring to FIG. 1, a glove box 10 may be installed on a dashboard (not illustrated) to provide storage space for an occupant riding in a vehicle.

The glove box 10 according to the present embodiment may have an accommodation space 11 formed therein, and be formed to have a box shape with one side thereof open. The glove box 10 may be rotatably connected to the dashboard. The glove box 10 may be received into the dashboard or withdrawn to the outside of the dashboard depending on a rotation direction of the glove box 10, and may selectively expose the accommodation space 11 to the occupant compartment.

The air damper 20 may be connected to the dashboard and the glove box 10, and may control a rotation speed of the glove box 10.

More specifically, when the glove box 10 is opened, the air damper 20 may maintain a constant opening speed of the glove box 10 by adding a damping force to the glove box 10 in a direction that offsets a load of the glove box 10 itself and a load of items stored in the accommodation space 11.

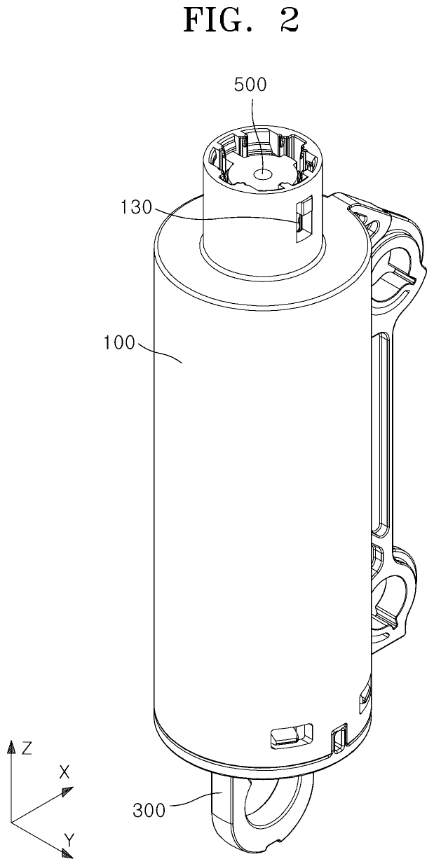

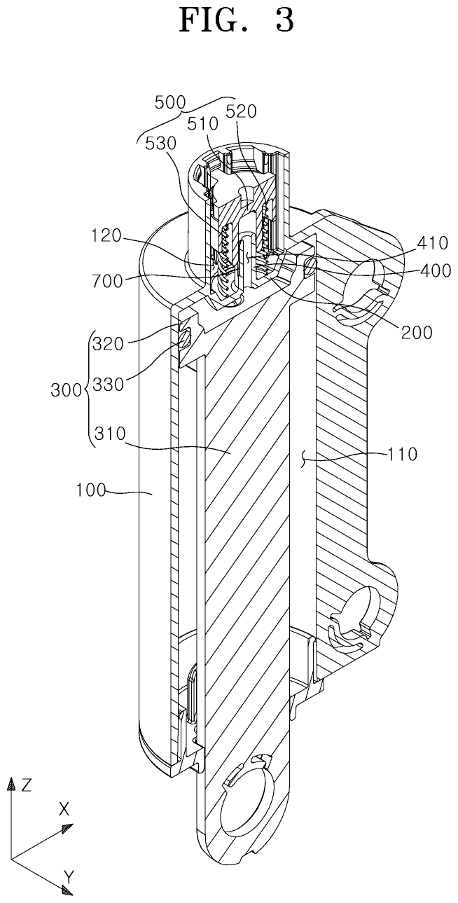

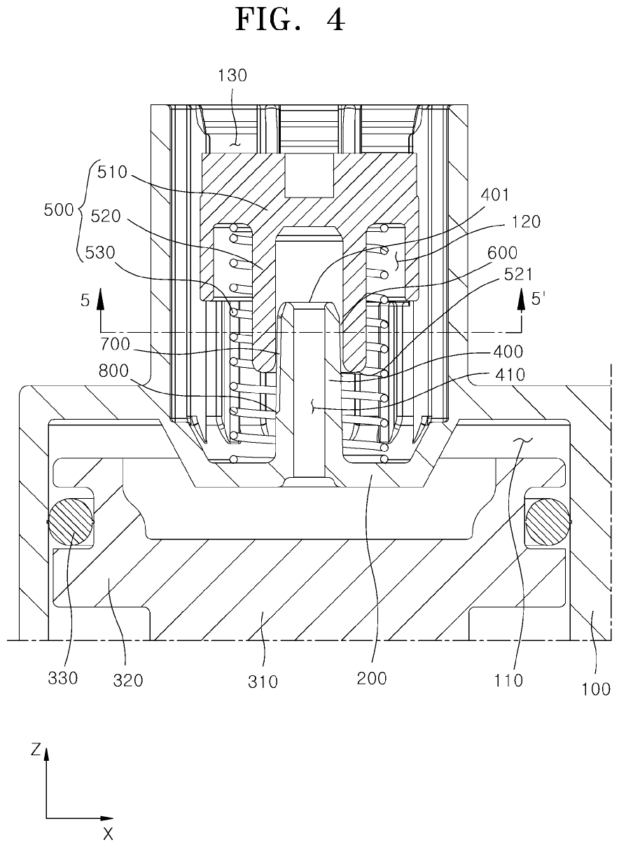

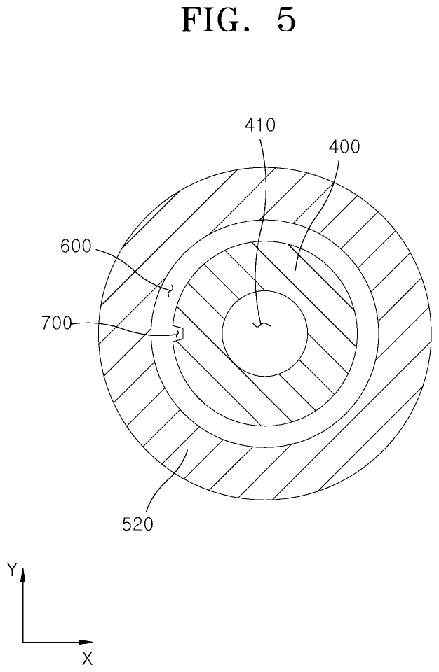

FIG. 2 is a perspective view schematically illustrating the configuration of the air damper panel according to an embodiment of the present disclosure. FIG. 3 is a cross-sectional perspective view schematically illustrating the configuration of the air damper according to an embodiment of the present disclosure. FIG. 4 is an enlarged view schematically illustrating the configuration of the air damper according to an embodiment of the present disclosure. FIG. 5 is a cross-sectional view taken along line 5-5′ in FIG. 4.

Referring to FIGS. 1 to 5, the air damper according to the present embodiment may include a cylinder 100, a partition wall 200, a piston 300, a guide rod 400, a valve 500, an orifice 600, and a slit 700.

The cylinder 100 may form an approximate exterior appearance of the air damper 20 and support as a whole the partition wall 200, the piston 300, the guide rod 400, and the valve 500.

The cylinder 100 according to the present embodiment may be formed to have a hollow interior and a tubular shape with openings on both sides thereof. The cross-sectional shape of the cylinder 100 may vary with a design change, such as polygonal, oval, and other shapes, in addition to the circular shape illustrated in FIGS. 2 and 3.

The cylinder 100 may be connected to the dashboard. To ensure smooth rotation of the glove box 10, the cylinder 100 may be rotatably connected to the dashboard by means of a hinge or the like. However, the cylinder 100 is not limited thereto, but may also be connected to the glove box 10.

The cylinder 100 may include a first chamber 110 and a second chamber 120.

The first chamber 110 and the second chamber 120 according to the present embodiment may refer to an empty space formed inside the cylinder 100. The first chamber 110 and the second chamber 120 may be arranged along a longitudinal direction of the cylinder 100 (the Z-axis direction in FIG. 3). That is, the first chamber 110 and the second chamber 120 may each refer to different spaces, within the internal space of the cylinder 100, arranged along the longitudinal direction of the cylinder 100 to face each other. The first chamber 110 and the second chamber 120 may each be connected to an external space of the cylinder 100 through the openings on both sides of the cylinder 100. The first chamber 110 and the second chamber 120 may be formed such that the two chambers' cross-sections perpendicular to the longitudinal direction of the cylinder 100 may have different areas, or alternatively may have the same areas. Cross-sectional shapes of the first chamber 110 and the second chamber 120 may vary with a design change, such as polygonal, oval, and other shapes, in addition to a circular shape.

The cylinder 100 may further include an inlet hole 130.

The inlet hole 130 according to the present embodiment may be formed to have a hole shape penetrating a peripheral surface of the cylinder 100. The inlet hole 130 may be arranged to face the second chamber 120. That is, the inlet hole 130 may function as an element that connects the external space of the cylinder with the second chamber 120 through the peripheral surface of the cylinder 100. The inlet hole 130 may have a long-hole shape extending in a longitudinal direction along the longitudinal direction of the cylinder 100.

FIG. 2 illustrates a single inlet hole 130 being formed as an example. However, the inlet hole 130 is not limited thereto, but a plurality of the inlet holes 130 may be provided. In this case, the plurality of the inlet holes 130 may be arranged along the peripheral surface of the cylinder 100, centered around a central axis of the cylinder 100. Each of the inlet holes 130 parallel to the longitudinal direction of the cylinder 100 may be formed to have different lengths.

The partition wall 200 may divide the internal space of the cylinder 100 into the first chamber 110 and the second chamber 120.

The partition wall 200 according to the present embodiment may be formed to have roughly a plate shape. The partition wall 200 may be arranged between the first chamber 110 and the second chamber 120. A cross-sectional shape of the partition wall 200 may be formed to correspond to the cross-sectional shapes of the first chamber 110 and the second chamber 120. The partition wall 200 may be arranged such that a central axis thereof is coaxial with the central axis of the cylinder 100. Two surfaces of the partition wall 200 may be arranged to face, respectively, one end of the first chamber 110 (the upper end in FIG. 3) arranged to be directed toward the second chamber 120 and one end of the second chamber 120 (the lower end in FIG. 3) arranged to be directed toward the first chamber 110. A peripheral surface of the partition wall 200 may come into contact with an inner peripheral surface of the cylinder 100, and may be fixed to the inner peripheral surface of the cylinder 100 by welding or the like.

A central portion of the partition wall 200 may be formed to be recessed from the second chamber 120 toward the first chamber 110. Accordingly, the partition wall 200 may expand a space in which the valve 500, which will be described later, may move within the second chamber 120.

The piston 300 may be movably installed in the first chamber 110. The piston 300 may be connected with the glove box 10. The piston 300 may function as a moving element that moves relative to the cylinder 100 when the glove box 10 is opened and closed.

The piston 300 according to the present embodiment may include a piston rod 310, a piston head 320, and a sealing member 330.

The piston rod 310 may form an exterior appearance of one side of the piston 300, and may be connected to the glove box 10.

The piston rod 310 according to the present embodiment may be formed to have a rod shape arranged in a longitudinal direction parallel to the longitudinal direction of the cylinder 100. The piston rod 310 may be arranged such that a central axis thereof is coaxial with the central axis of the cylinder 100. The piston rod 310 may be formed to have a smaller cross-sectional area than the first chamber 110.

One end of the piston rod 310 (the upper end in FIG. 3) may be arranged inside the first chamber 110. One end of the piston rod 310 may be arranged to be spaced apart from the partition wall 200 along the longitudinal direction of the cylinder 100. The other end of the piston rod 310 (the lower end in FIG. 3) may protrude to the outside of the cylinder 100 through an open side of the first chamber 110.

The other end of the piston rod 310 may be connected to the glove box 10. The other end of the piston rod 310 may be rotatably connected to the glove box 10 by means of a hinge or the like so as not to interfere with opening and closing operation of the glove box 10. During the opening and closing operation of the glove box 10, the piston rod 310 may move linearly along the longitudinal direction of the cylinder 100 inside the first chamber 110. For example, when the glove box 10 is opened, the one end, facing the partition wall 200, of the piston rod 310 may move in a direction away from the partition wall 200. When the glove box 10 is closed, the one end, facing the partition wall 200, of the piston rod 310 may move in a direction closer to the partition wall 200.

The piston head 320 may form an exterior appearance of the other side of the piston 300, and may support the sealing member 330.

The piston head 320 according to the present embodiment may be connected to one end, facing the partition wall 200, of the piston rod 310. The piston head 320 may be formed to have a larger cross-sectional area than the piston rod 310 and a smaller cross-sectional area than the first chamber 110. The piston head 320 may be arranged such that an outer peripheral surface thereof is spaced a predetermined distance apart from the inner peripheral surface of the cylinder 100. When the piston rod 310 moves, the piston head 320 may move, with the piston rod 310, along the longitudinal direction of the cylinder 100 inside the first chamber 110.

The sealing member 330 may seal between the cylinder 100 and the piston head 320. That is, the sealing member 330 may function as an element that prevents air between the partition wall 200 and the piston head 320 from leaking to the open side of the first chamber 110 when the piston 300 operates.

The sealing member 330 according to the present embodiment may be arranged between the inner peripheral surface of the cylinder 100 and the outer peripheral surface of the piston head 320. The sealing member 330 may be formed to have a ring shape, which entirely surrounds the outer peripheral surface of the piston head 320. The sealing member 330 may be formed of an elastically deformable material such as rubber, silicone, and the like. Accordingly, two sides of the sealing member 330 may come into close contact, by an elastic resilience thereof, with the inner peripheral surface of the cylinder 100 and the outer peripheral surface of the piston head 320.

The piston 300 may adjust, based on a movement direction thereof, the pressure of the first chamber 110. For example, when the glove box 10 is opened, the piston head 320 may move in a direction away from the partition wall 200, thereby reducing pressure in a space, within the entire space of the first chamber 110, formed between the partition wall 200 and the piston head 320. When the glove box 10 is closed, the piston head 320 may move in a direction toward the partition wall 200, thereby increasing pressure in the space, within the entire space of the first chamber 110, formed between the partition wall 200 and the piston head 320.

A lubricant such as grease and the like may be applied to the inner peripheral surface of the cylinder 100. Accordingly, the sealing member 330 may move smoothly along the inner peripheral surface of the cylinder 100 while sealing between the cylinder 100 and the piston head 320.

The guide rod 400 may extend from the partition wall 200 toward the second chamber 120, and may guide air transfer between the first chamber 110 and the second chamber 120.

The guide rod 400 according to the present embodiment may be formed to have a rod shape extending from one surface, facing the second chamber 120 (the top surface in FIG. 4), of the partition wall 200 toward the second chamber 120. A central axis of the guide rod 400 may be positioned coaxially with the central axis of the cylinder 100. The guide rod 400 may be formed to have a smaller cross-sectional area than the second chamber 120.

A guide end surface 401 may be formed at an end of the guide rod 400 extending toward the second chamber 120. The guide end surface 401 according to the present embodiment may be arranged to face, along the longitudinal direction of the cylinder 100, an open side of the second chamber 120. The guide end surface 401 may be arranged perpendicular to the longitudinal direction of the cylinder 100 and a central axis of the guide rod 400.

The guide rod 400 may include a transfer hole 410.

The transfer hole 410 according to the present embodiment may be formed to have a hole shape penetrating the guide rod 400 along the longitudinal direction of the cylinder 100. One end of the transfer hole 410 (the lower portion in FIG. 4) may penetrate the partition wall 200 and be connected to the first chamber 110. The other end of the transfer hole 410 (the upper portion in FIG. 4) may penetrate the guide end surface 401, and may be connected to the second chamber 120. Accordingly, the transfer hole 410 may function as a passage that mediates air transfer between the first chamber 110 and the second chamber 120. The cross-sectional shape of the transfer hole 410 may vary with a design change, such as polygonal, oval, and other shapes, in addition to a circular shape.

A cross-sectional area of the guide rod 400 according to the present embodiment may increase toward the partition wall 200. The outer peripheral surface of the guide rod 400 may be formed to have a tapered shape arranged to be inclined with respect to the longitudinal direction of the cylinder 100. The inclination angle of the outer peripheral surface of the guide rod 400 may vary with a design change within a range of intersection with the longitudinal direction of the cylinder 100.

The valve 500 may be movably installed in the second chamber 120. The valve 500 may move in conjunction with a pressure difference between the first chamber 110 and the second chamber 120. More specifically, the valve 500 may move linearly along the longitudinal direction of the cylinder 100 within the second chamber 120 by the pressure difference generated between the first chamber 110 and the second chamber 120 when the piston 300 moves.

The valve 500 according to the present embodiment may include a valve body 510, a valve rod 520, and an elastic member 530.

The valve body 510 may be formed to have roughly a plate shape, and may be arranged within the second chamber 120. The valve body 510 may be arranged such that a central axis thereof is coaxial with the central axis of the cylinder 100. An outer peripheral surface of the valve body 510 may come into contact with or be connected to the inner peripheral surface of the cylinder 100 surrounding the second chamber 120, so as to be slidably movable. One surface of the valve body 510 (the top surface in FIG. 4) may be arranged to face the open side of the second chamber 120. The other surface of the valve body 510 (the bottom surface in FIG. 4) may be arranged to be spaced a predetermined distance apart, along the longitudinal direction of the cylinder 100, from the guide end surface 401 of the guide rod 400 to face the same.

When the glove box 10 is opened, the piston 300 may move in a direction away from the partition wall 200, and an internal pressure of the first chamber 110 may decrease. Accordingly, a negative pressure in a direction toward the first chamber 110 is formed in the second chamber 120, and the valve body 510 may move from the inside of the second chamber 120 toward the partition wall 200.

The valve body 510 may be arranged at a greater height than the lower end of a inlet hole 130. Accordingly, regardless of the moving distance of the valve body 510, air outside the cylinder 100 may continuously flow into the second chamber 120 through the inlet hole 130.

The valve rod 520 may extend from the valve body 510, and may be arranged to surround the guide rod 400.

The valve rod 520 according to the present embodiment may have a hollow rod shape extending from the other surface, facing the guide end surface 401, of the valve body 510 toward the partition wall 200. The valve rod 520 may be arranged such that a central axis thereof is coaxial with the central axes of the cylinder 100 and the guide rod 400. An area of an inner peripheral surface of the valve rod 520 may be larger than a maximum cross-sectional area of the guide rod 400 connected to the partition wall 200. The guide rod 400 may be inserted into the valve rod 520. An internal space of the valve rod 520 may be connected to the transfer hole 410. The valve rod 520 may be arranged such that the inner peripheral surface thereof is spaced a predetermined distance apart from and faces the outer peripheral surface of the guide rod 400.

Valve end surfaces 521 may be formed at ends of the valve rod 520 arranged, along the longitudinal direction of the cylinder 100, to face the partition wall 200. The valve end surfaces 521 according to the present embodiment may be arranged perpendicular to the longitudinal direction of the cylinder 100 and a central axis of the valve rod 520.

The elastic member 530 may be arranged between the partition wall 200 and the valve body 510, and may elastically support the valve body 510 on the partition wall 200. The elastic member 530 according to the present embodiment may have a coil-spring shape, which is stretchable along a longitudinal direction thereof. The elastic member 530 may be arranged within the second chamber 120 such that a central axis of the elastic member 530 is coaxial with the central axis of the cylinder 100. Two ends of the elastic member 530 may be fixed to opposing surfaces of the partition wall 200 and the valve body 510, respectively. When the valve body 510 moves, the elastic member 530 may elastically deform itself, and may add an elastic force in the opposite direction of the movement of the valve body 510. Accordingly, when the glove box 10 is opened, the elastic member 530 may adjust a moving distance of the valve body 510 in proportion to the magnitude of the load applied to the piston 300, and may return the valve body 510 to the initial position thereof in the absence of an external force.

The orifice 600 may be arranged between the guide rod 400 and the valve 500. The orifice 600 may function as an element that generates a damping force applied to the piston 300 by reducing an area of air flow between the second chamber 120 and the transfer hole 410.

The orifice 600 according to the present embodiment may be exemplified by an empty space formed between the outer peripheral surface of the guide rod 400 and the inner peripheral surface of the valve rod 520. The orifice 600 may be formed to have a shape of a ring-shaped flow path surrounding the outer peripheral surface of the guide rod 400. The orifice 600 may be positioned such that a central axis thereof is coaxial with the central axes of the cylinder 100 and the guide rod 400. One end of the orifice 600 (the lower end in FIG. 4) may be connected to the second chamber 120 through the valve end surface 521. The other end of the orifice 600 (the upper end in FIG. 4) may be connected to the transfer hole 410 through the guide end surface 401.

As the outer peripheral surface of the guide rod 400 is formed to be inclined with respect to a moving direction of the valve 500, a cross-sectional area of the orifice 600 may increase or decrease depending on the moving direction of the valve 500. For example, as the valve body 510 moves toward the partition wall 200, the gap between the valve rod 520 and the guide rod 400 may decrease, and the cross-sectional area of the orifice 600 may decrease. As the valve body 510 moves away from the partition wall 200, the gap between the valve rod 520 and the guide rod 400 may increase, and the cross-sectional area of the orifice 600 may increase. Accordingly, the valve 500 may change the magnitude of the damping force applied to the piston 300 based on a change in the load of the glove box 10, thereby maintaining a constant opening speed of the glove box 10.

The slit 700 may be provided in the guide rod 400 or the valve 500, and may be connected to the orifice 600. A volume of the slit 700 may vary in conjunction with a change in a volume of the guide rod 400 or the valve 500. Accordingly, the slit 700 may function as an element that compensates for a decrease in the area of the orifice 600 caused by thermal expansion of the guide rod 400 or the valve 500 in a high temperature environment.

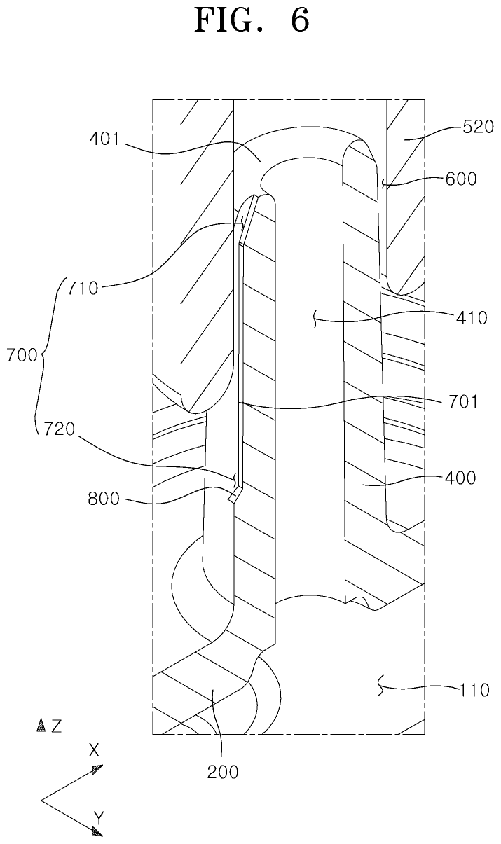

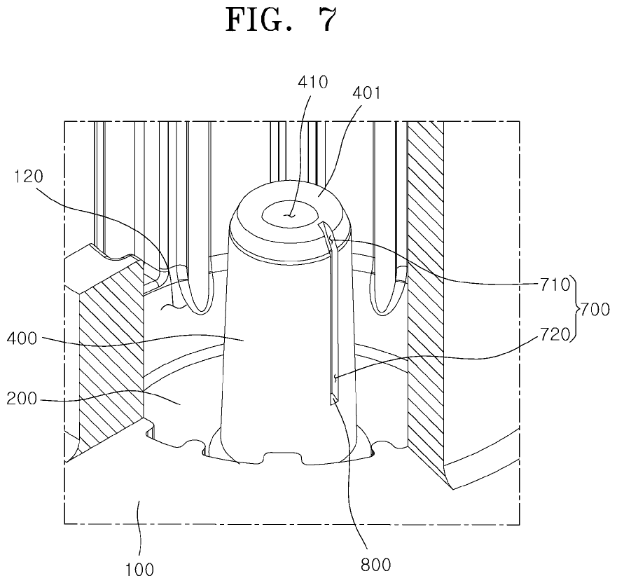

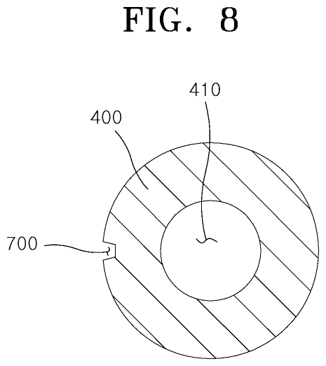

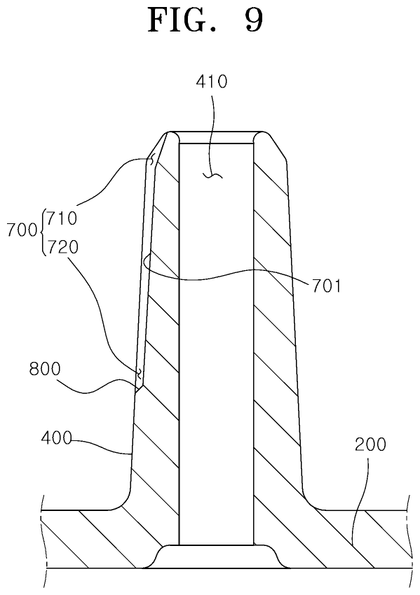

FIG. 6 is a view schematically illustrating the installation state of a slit according to an embodiment of the present disclosure. FIG. 7 is a perspective view schematically illustrating the configuration of the slit according to an embodiment of the present disclosure. FIGS. 8 and 9 are cross-sectional views schematically illustrating the configuration of the slit according to an embodiment of the present disclosure.

Referring to FIGS. 6 to 9, the slit 700 according to the present embodiment may have a groove shape formed to be recessed in a first direction from the outer peripheral surface of the guide rod 400. Here, the first direction is a direction perpendicular to the outer peripheral surface of the guide rod 400. The first direction may vary with a design change within a range of intersection with the central axis of the guide rod 400 based on the inclination angle of the outer peripheral surface of the guide rod 400.

A bottom surface 701 perpendicular to the first direction may be formed inside the slit 700. The bottom surface 701 of the slit 700 may refer to a portion, out of the entire outer peripheral surface of the guide rod 400, formed inside the slit 700.

A depth of the slit 700 may refer to a vertical distance from the bottom surface 701 of the slit 700 to the outer peripheral surface of the guide rod 400 removed by the slit 700.

A width of the slit 700 may refer to a distance between two sides of the slit 700 spaced apart from each other along a circumferential direction of the guide rod 400.

The width of the slit 700 may increase toward the outer peripheral surface of the guide rod 400. For example, as illustrated in FIG. 8, a cross-section, perpendicular to the longitudinal direction of the cylinder 100, of the slit 700 may have a trapezoidal shape.

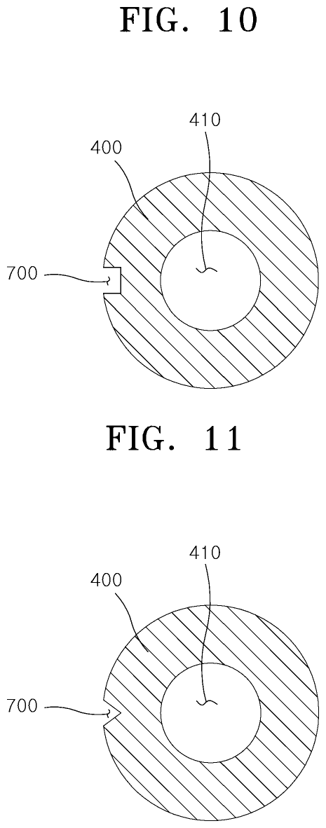

FIGS. 10 and 11 are views illustrating modifications of the cross-sectional shape of the slit according to an embodiment of the present disclosure.

Referring to FIG. 10, the cross-section, perpendicular to the longitudinal direction of the cylinder 100, of the slit 700 may have a triangular shape with the vertex arranged to face the bottom surface 701 of the slit 700.

Referring to FIG. 11, the width of the slit 700 may remain constant toward the outer peripheral surface of the guide rod 400. For example, as illustrated in FIG. 8, the cross-section, perpendicular to the longitudinal direction of the cylinder 100, of the slit 700 may have a square or rectangular shape.

The slit 700 may extend in a longitudinal direction along a second direction perpendicular to the first direction. The slit 700 may include a first end 710 and a second end 720 spaced apart from each other along the second direction. Here, the second direction may refer to a direction facing the partition wall 200 from the guide end surface 401 and parallel to an extension direction of the outer peripheral surface of the guide rod 400, out of directions perpendicular to the first direction. The first end 710 and the second end 720 may be arranged to face the guide end surface 401 of the guide rod 400 and the partition wall 200, respectively.

A distance between the first end 710 and the second end 720 may be greater than the width of the slit 700 formed along the circumferential direction of the guide rod 400. That is, the slit 700 may be formed to have a straight-groove shape with the length in the second direction which is greater than the width in the circumferential direction of the guide rod 400.

The first end 710 of the slit 700 may penetrate the guide end surface 401. The second end 720 of the slit 700 may be arranged at a position spaced a predetermined distance apart from the partition wall 200 in the extension direction of the outer peripheral surface of the guide rod 400, which is a direction parallel to the second direction.

The air damper 20 according to the present embodiment may further include an inclined surface 800.

The inclined surface 800 may be arranged to face the second end 720 of the slit 700, and may have a shape of an inclined surface extending obliquely from the outer peripheral surface of the guide rod 400 toward the bottom surface 701 of the slit 700. That is, the inclined surface 800 may function as an element that linearly connects the outer peripheral surface of the guide rod 400 and the bottom surface 701 of the slit 700 in a region in which the second end 720 of the slit 700 is formed. Accordingly, the inclined surface 800 may prevent a non-linear change in a damping force by preventing the cross-sectional area of the orifice 600 from changing rapidly in the region between the outer peripheral surface of the guide rod 400 and the bottom surface 701 of the slit 700 when the valve rod 520 passes through the second end 720. The angle between the inclined surface 800 and the bottom surface 701 of the slit 700 may be about 135°. However, the angle between the inclined surface 800 and the bottom surface 701 of the slit 700 is not limited thereto, but may vary with a design change within the range between 90° and 180°.

Hereinafter, an operation of the air damper 20 according to an embodiment of the present disclosure will be described.

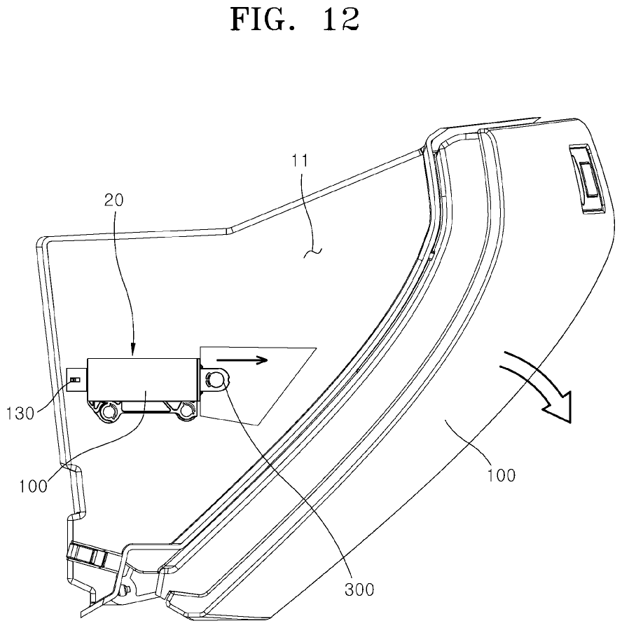

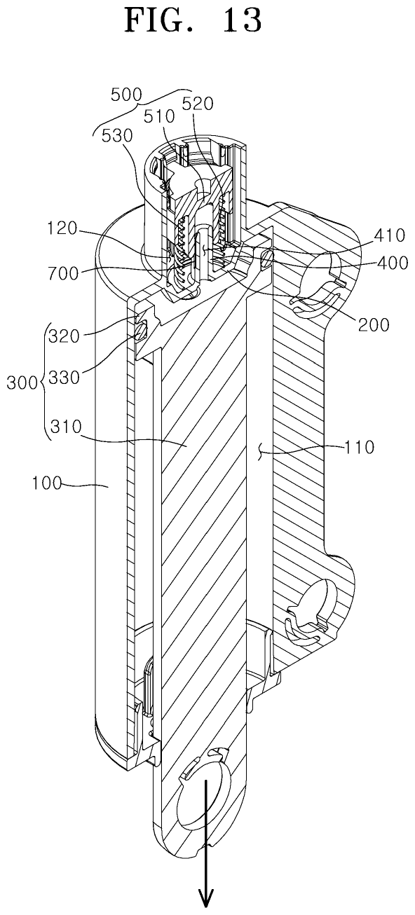

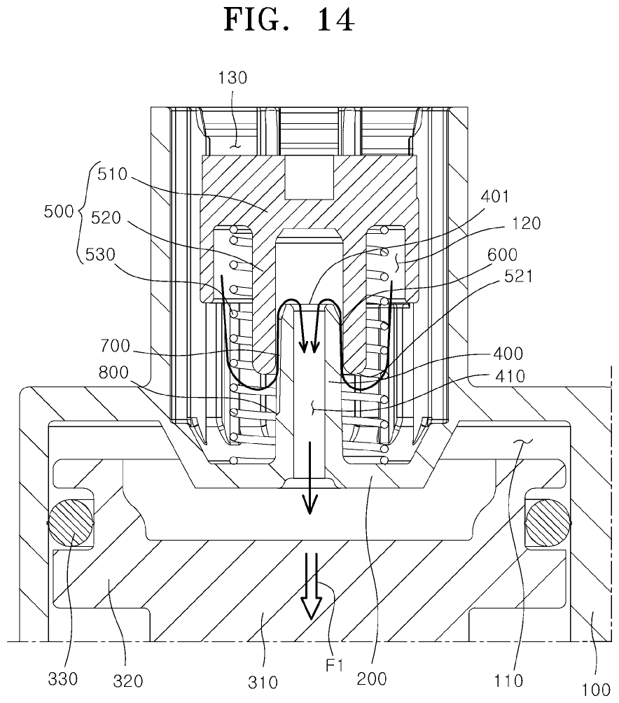

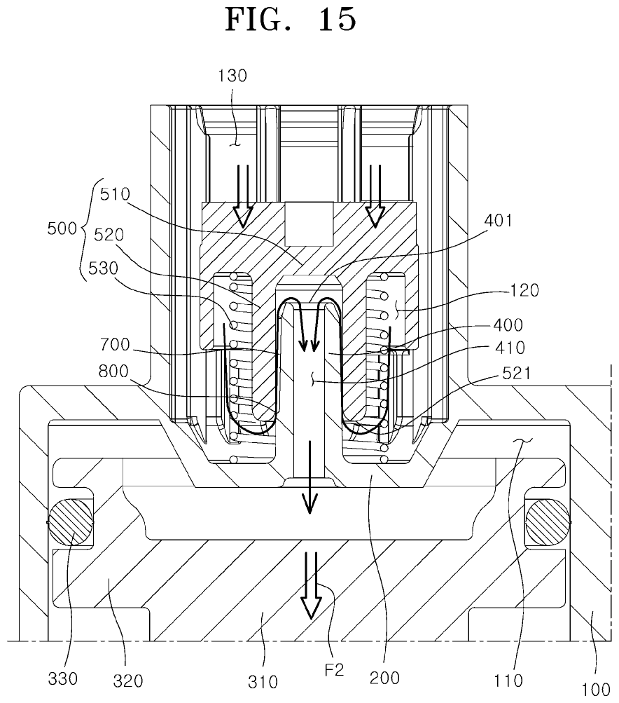

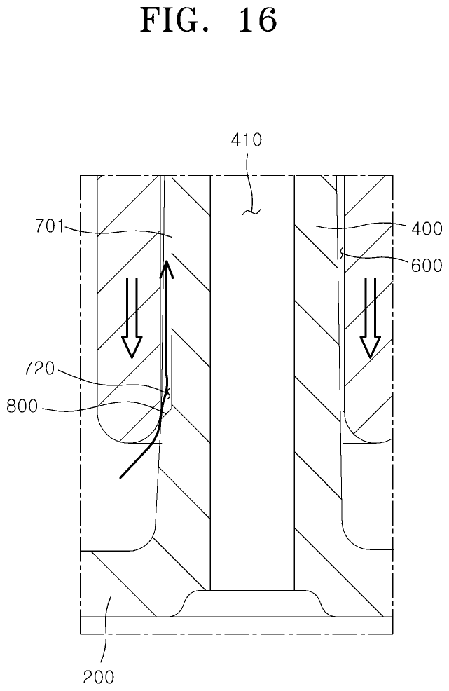

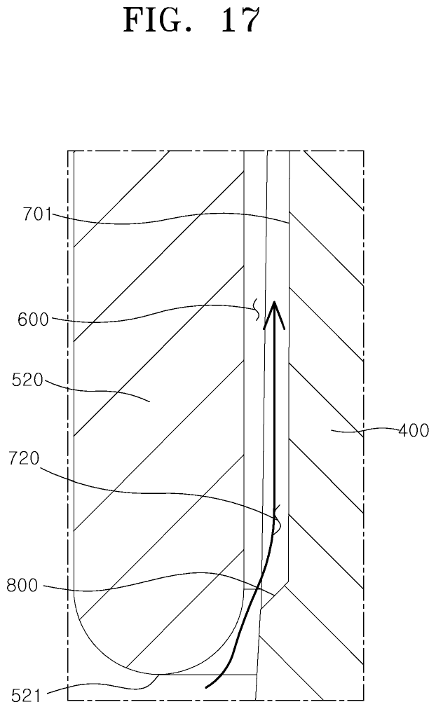

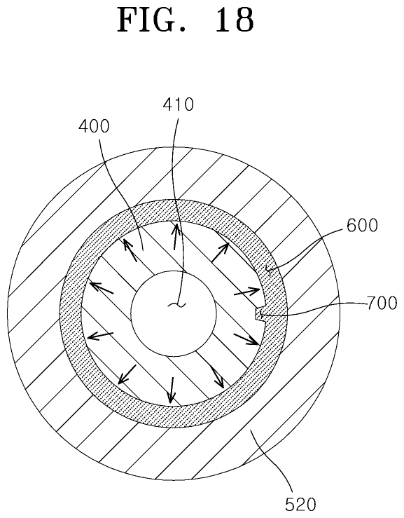

FIG. 12, FIG. 13, FIG. 14, FIG. 15, FIG. 16, FIG. 17, FIG. 18, and FIG. 19 are views schematically illustrating an operation process of the air damper according to an embodiment of the present disclosure.

Referring to FIGS. 12 and 13, when the glove box 10 is opened, a load is applied to the piston 300 in the opening direction of the glove box 10 due to the weight of the glove box 10 itself and the weight of items accommodated in the accommodation space 11, and the like.

The piston 300 moves, by the load, in a straight line in a direction in which the piston head 320 moves away from the partition wall 200.

By the movement of the piston head 320, a space formed between the piston head 320 and the partition wall 200 expands, and an internal pressure of the first chamber 110 decreases.

Referring to FIG. 14, as the internal pressure of the first chamber 110 decreases, the air inside the second chamber 120 sequentially passes through the orifice 600 and the transfer hole 410 to be transferred to the first chamber 110.

In this process, the orifice 600 may be formed to have a relatively smaller area than the second chamber 120 and the transfer hole 410. Thus, as the air transferred to the first chamber 110 passes through the orifice 600, friction with the guide rod 400 and the piston rod 520 generates a damping force in the air.

The damping force may act to offset the load applied to the piston 300 so as to decrease the speed of movement of the piston 300, thereby maintaining a constant opening speed of the glove box 10.

Referring to FIG. 15, when the glove box 10 is opened, if the load applied to the piston 300 increases due to an increase in the weight of items accommodated in the accommodation space 11, the internal pressure of the first chamber 110 decreases by a relatively larger extent.

As the pressure difference between the first chamber 110 and the second chamber 120 increases, the valve 500 moves a relatively greater distance toward the partition wall 200 than in the case of FIG. 14.

As the guide rod 400 is formed to have a larger cross-sectional area toward the partition wall 200, the cross-sectional area of the orifice 600 may decrease by a relatively larger extent than in the case of FIG. 14, and the magnitude of the damping force applied to the piston 300 may increase.

Accordingly, the glove box 10 may be opened at a constant speed regardless of the change in the load applied to the piston 300.

Referring to FIGS. 16 and 17, when the valve 500 moves, the cross-sectional area of the orifice 600 may change rapidly at a point in which the second end 720 of the slit 700 is located due to the difference in depth between the outer peripheral surface of the guide rod 400 and the bottom surface 701 of the slit 700. Accordingly, with an end of the orifice 600 located at the boundary point between the second end 720 and the guide rod 400, when a slight change in the load on the piston 300 occurs, the opening speed of the glove box 10 may become inconsistent.

In the present embodiment, when the inner peripheral surface of the valve 500 passes through the second end 720, an inconsistent increase or decrease in the opening speed of the glove box 10 may be prevented by linearly changing the cross-sectional area of the orifice 600 by using the inclined surface 800 formed to be inclined from the outer peripheral surface of the guide rod 400 toward the bottom surface 701 of the slit 700.

Referring to FIGS. 18 and 19, when the air damper 20 according to the present embodiment is exposed to a high temperature environment, the guide rod 400 may be thermally expanded.

When the guide rod 400 is thermally expanded, the cross-sectional area of the guide rod 400 may increase in the circumferential and radial directions.

Due to the expansion of the guide rod 400 in the radial direction, the gap between the outer peripheral surface of the guide rod 400 and the inner peripheral surface of the valve rod 520 decreases, and the cross-sectional area of the orifice 600 also decreases.

Meanwhile, due to the expansion of the guide rod 400 in the circumferential direction, the width of the slit 700 parallel to the circumferential direction of the guide rod 400 increases.

As the slit 700 is connected to the orifice 600, the decrease in the cross-sectional area of the orifice 600 due to thermal expansion of the guide rod 400 may be offset to a certain extent by the increase in the cross-sectional area of the slit 700.

Accordingly, the slit 700 may prevent the opening time of the glove box 10 from excessively increasing when the guide rod 400 thermally expands.

Hereinafter, the air damper 20 according to another embodiment of the present disclosure will be described.

The air damper 20 according to the present embodiment may be configured to differ, from the air damper 20 according to an embodiment of the present disclosure described with reference to FIGS. 1 to 19, only in the detailed configuration of the guide rod 400, the valve rod 520, and the slit 700.

Accordingly, in describing the air damper 20 according to the present embodiment, only the detailed configuration of the guide rod 400, the valve rod 520 and the slit 700, which is different from that of the air damper 20 according to an embodiment of the present disclosure will be described.

For the rest of the configuration of the air damper 20 according to the present embodiment, the same description of the air damper 20 according to an embodiment of the disclosure may be applied.

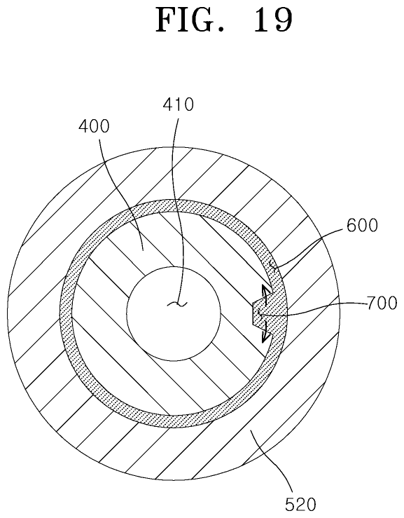

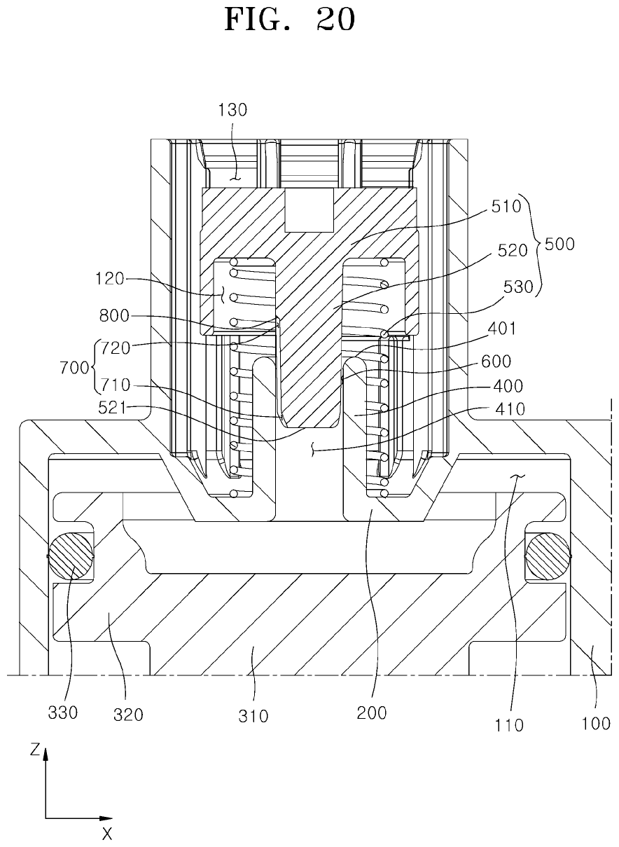

FIG. 20 is a cross-sectional view schematically illustrating the configuration of the air damper according to another embodiment of the present disclosure.

Referring to FIG. 20, the guide rod 400 according to the present embodiment may be formed such that the cross-sectional area of thereof remains constant along the longitudinal direction of the cylinder 100. That is, the outer peripheral surface of the guide rod 400 may be arranged perpendicular to the central axis of the guide rod 400.

The valve rod 520 according to the present embodiment may be formed to have a smaller cross-sectional area than the transfer hole 410 formed inside the guide rod 400.

The valve rod 520 may be inserted into the transfer hole 410. The valve rod 520 may be arranged such that the outer peripheral surface thereof is spaced a predetermined distance apart from and faces an inner peripheral surface of the guide rod 400.

The valve rod 520 according to the present embodiment may have a hollow rod shape extending from the other surface, facing the guide end surface 401, of the valve body 510 toward the partition wall 200. The valve rod 520 may be arranged such that a central axis thereof is coaxial with the central axes of the cylinder 100 and the guide rod 400. The valve rod 520 may be formed such that the area of the inner peripheral surface thereof is larger than the maximum cross-sectional area of the guide rod 400 connected to the partition wall 200. The guide rod 400 may be inserted into the valve rod 520. The internal space of the valve rod 520 may be connected to the transfer hole 410. The valve rod 520 may be arranged such that the outer peripheral surface thereof is spaced a predetermined distance apart from and faces the inner peripheral surface of the guide rod 400.

The cross-sectional area of the valve rod 520 may decrease toward the partition wall 200. The outer peripheral surface of the valve rod 520 may be formed to have a tapered shape arranged to be inclined with respect to the longitudinal direction of the cylinder 100. The inclination angle of the outer peripheral surface of the valve rod 520 may vary with a design change within a range of intersection with the longitudinal direction of the cylinder 100.

The orifice 600 according to the present embodiment may be arranged between the outer peripheral surface of the valve rod 520 and the inner peripheral surface of the guide rod 400. In the present embodiment, the orifice 600 may refer to a portion, within the entire region of the transfer hole 410 formed inside the guide rod 400, formed between the outer peripheral surface of the valve rod 520 and the inner peripheral surface of the guide rod 400.

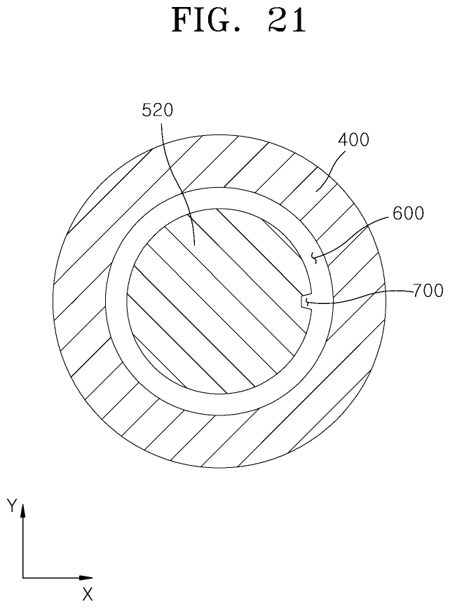

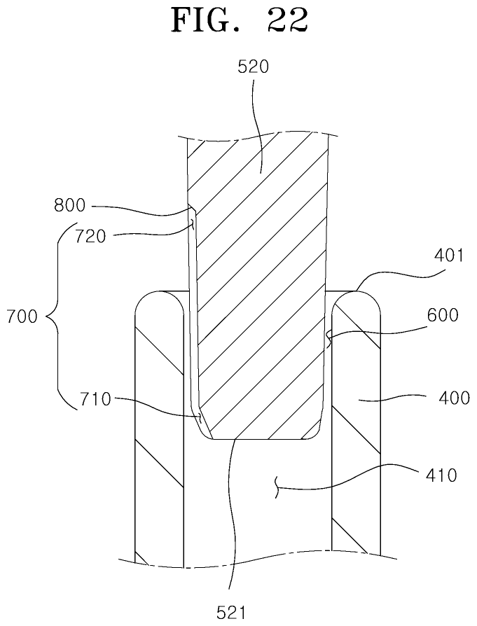

FIGS. 21 and 22 are cross-sectional views schematically illustrating the configuration of the slit according to another embodiment of the present disclosure.

Referring to FIGS. 20 to 22, the slit 700 according to the present embodiment may have a shape of a groove formed to be recessed in the first direction from the outer peripheral surface of the valve rod 520. Here, the first direction is a direction perpendicular to the outer peripheral surface of the valve rod 520. The first direction may vary with a design change within a range of intersection with the central axis of the valve rod 520 based on the inclination angle of the outer peripheral surface of the valve rod 520.

The bottom surface 701 perpendicular to the first direction may be formed inside the slit 700. The bottom surface 701 of the slit 700 may refer to a portion, within the entire outer peripheral surface of the valve rod 520, formed inside the slit 700.

The depth of the slit 700 may refer to a vertical distance from the bottom surface 701 of the slit 700 to the outer peripheral surface of the valve rod 520 removed by the slit 700.

The width of the slit 700 may refer to a distance between two sides of the slit 700 spaced apart from each other along the circumferential direction of the valve rod 520.

The width of the slit 700 may increase toward the outer peripheral surface of the valve rod 520. For example, the cross-section, perpendicular to the longitudinal direction of the cylinder 100, of the slit 700 may have a trapezoidal or triangular shape.

Alternatively, the width of the slit 700 may remain constant toward the outer peripheral surface of the valve rod 520. For example, the cross-section, perpendicular to the longitudinal direction of the cylinder 100, of the slit 700 may have a square or rectangular shape.

The slit 700 may extend in a longitudinal direction along a second direction perpendicular to the first direction. The slit 700 may include a first end 710 and a second end 720 spaced apart from each other along the second direction. Here, the second direction may refer to a direction facing the valve body 510 from the valve end surface 521 and parallel to an extension direction of the outer peripheral surface of the valve rod 520, out of directions perpendicular to the first direction. The first end 710 and the second end 720 may be arranged to face the valve end surface 521 of the valve rod 520 and the valve body 510, respectively.

The distance between the first end 710 and the second end 720 may be greater than the width of the slit 700 formed along the circumferential direction of the valve rod 520. That is, the slit 700 may be formed to have a straight-groove shape with a length in the second direction which is greater than the width in the circumferential direction of the valve rod 520.

The first end 710 of the slit 700 may penetrate the valve end surface 521. The second end 720 of the slit 700 may be arranged at a position spaced a predetermined distance apart from the valve body 510 in the extension direction of the outer peripheral surface of the valve rod 520, which is a direction parallel to the second direction.

The inclined surface 800 according to the present embodiment may be arranged to face the second end 720 of the slit 700, and may have a shape of an inclined surface extending obliquely from the outer peripheral surface of the valve rod 520 toward the bottom surface 701 of the slit 700. That is, the inclined surface 800 may function as an element that linearly connects the outer peripheral surface of the valve rod 520 and the bottom surface 701 of the slit 700 in a region in which the second end 720 of the slit 700 is formed. Accordingly, the inclined surface 800 may prevent a non-linear change in a damping force by preventing the cross-sectional area of the orifice 600 from changing rapidly in the region between the outer peripheral surface of the valve rod 520 and the bottom surface 701 of the slit 700 when the valve 500 moves. The angle between the inclined surface 800 and the bottom surface 701 of the slit 700 may be about 135°. However, the angle between the inclined surface 800 and the bottom surface 701 of the slit 700 is not limited thereto, but may vary with a design change within the range between 90° and 180°.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An air damper comprising:
a cylinder;
a partition wall dividing an internal space of the cylinder into a first chamber and a second chamber;
a piston movably installed in the first chamber;
a guide rod extending from the partition wall toward the second chamber and comprising a transfer hole connected to the first chamber and the second chamber;
a valve movably installed in the second chamber and configured to move in conjunction with a pressure difference between the first chamber and the second chamber;
an orifice positioned between the guide rod and the valve and connected to the second chamber and the transfer hole; and
a slit provided on the guide rod or the valve and connected to the orifice.

2. The air damper of claim 1, wherein the valve comprises:
a valve body;
a valve rod extending from the valve body and surrounding the guide rod; and
an elastic member positioned between the partition wall and the valve body,
wherein the slit is provided on the guide rod and is recessed in a first direction from an outer peripheral surface of the guide rod.

3. The air damper of claim 2, wherein a cross-sectional area of the guide rod increases toward the partition wall.

4. The air damper of claim 3, wherein the guide rod is arranged relative to the valve such that the outer peripheral surface thereof is inclined with respect to a moving direction of the valve.

5. The air damper of claim 2, wherein a width of the slit increases toward an outer peripheral surface of the valve.

6. The air damper of claim 2, wherein the slit comprises a first end and a second end spaced apart from the first end along a second direction perpendicular to the first direction, and
wherein a distance between the first end and the second end is greater than a width of the slit.

7. The air damper of claim 6, wherein the guide rod comprises a guide end surface perpendicular to a moving direction of the valve, and
wherein the first end of the slit penetrates the guide end surface of the guide rod.

8. The air damper of claim 6, further comprising an inclined surface facing the second end of the slit and extending obliquely from the outer peripheral surface of the guide rod toward a bottom surface of the slit.

9. The air damper of claim 1, wherein the valve comprises:
a valve body;
a valve rod extending from the valve body into the transfer hole; and
an elastic member positioned between the partition wall and the valve body,
wherein the slit is provided on the valve rod and is recessed in a first direction from an outer peripheral surface of the valve rod.

10. The air damper of claim 9, wherein a cross-sectional area of the valve rod decreases toward the partition wall.

11. The air damper of claim 10, wherein the valve rod is arranged relative to the guide rod such that the outer peripheral surface thereof is arranged to be inclined with respect to a moving direction of the valve.

12. The air damper of claim 9, wherein a width of the slit increases toward the outer peripheral surface of the valve rod.

13. The air damper of claim 9, wherein the slit comprises a first end and a second end spaced apart from the first end along a second direction perpendicular to the first direction, and
wherein a distance between the first end and the second end is greater than a width of the slit.

14. The air damper of claim 13, wherein the valve rod comprises a valve end surface perpendicular to a moving direction of the valve body, and
wherein the first end of the slit penetrates the valve end surface of the guide rod.

15. The air damper of claim 13, further comprising an inclined surface facing the second end of the slit and extending obliquely from the outer peripheral surface of the valve rod toward a bottom surface of the slit.
